(19) United States
(12) Patent Application Publication
(10) Pub. No.: US 2004/0205317 A1
(43) Pub. Date: Oct. 14, 2004

(54) Method, apparatus and program storage device for providing data integrity using check data and other metadata on a formatted storage medium

(75) Inventors: Andrew Dale Walls, San Jose, CA (US); Michael Thomas Benhase, Pima, AZ (US); Carl Evan Jones, Tucson, AZ (US); John Charles Elliott, Tucson, AZ (US); Carol Spanel, San Jose, CA (US); Lih-Chung Kuo, San Jose, CA (US); William Garrett Verdoorn JR., Rochester, MN (US)

Correspondence Address: DAVID W. LYNCH, CRAWFORD MAUNU PLLC, 1270 NORTHLAND DRIVE, SUITE 390, MENDOTA HEIGHTS, MN, 55120, US

(73) Assignee: International Business Machines Corporation, Armonk, NY

(21) Appl. No.: 10/408,921

(22) Filed: Apr. 8, 2003

(51) Int. Cl. G06F 12/00

(52) U.S. Cl. 711/171; 711/112

(57) ABSTRACT

A method, apparatus and program storage device for providing data integrity using check data and other metadata on a formatted storage medium. A processor processes a first number of packets having first predetermined lengths sized for a first number of sectors on the medium and individual check data to form the first number of packets with second predetermined lengths having a total size that requires a second predetermined number of sectors for storage

### BACKGROUND OF THE INVENTION

1. Field of the Invention

The present invention relates to data storage systems and more particularly, to a method, apparatus and program storage device for providing data integrity using check data and other metadata on a formatted storage medium.

2. Description of Related Art

During recent years, computer scientists and data processing professionals, particularly those involved with the development of data storage systems, have developed guideline and benchmarks for data storage systems and data storage system data integrity or reliability. Consumers require an inexpensive storage system and rely on the integrity of those storage systems to provide storage and retrieval of error free data. A consumer can suffer serious financial repercussions when access to data is lost or if the data retrieved is wrong.

Hence, storage systems often employ a redundant array of independent disks (RAID) and other forms of error checking to help ensure that any errors that develop are caught quickly to enable recovery. A RAID provides various levels of data protection or integrity. RAID level 0 indicates that a particular data storage system has no mechanism providing data integrity or redundancy, while a RAID level 6 system is generally thought to provide the highest level of data protection currently developed. In such devices, a priority for each application is retaining data integrity at a minimal cost as data is transferred from the storage device to the host or server system.

Storage system devices may be connected via a small computer system interface (SCSI). SCSI is an interface technology that provides a high performance, highly reliable solution to increasing demands for speed and flexibility in storage devices. Today, SCSI is used for data storage applications in server systems, network attached storage (NAS) and storage area network (SAN) applications.

Generally, SCSI uses 512 byte sectors when reading data from and writing data to a storage device. Hence, computer operating systems will store or retrieve groups of 512 byte sectors. Moreover, most computer operating systems will fetch or write 8 sectors at a time thereby equating to 4096 or 4K bytes worth of data.

SCSI and FCAL drives tend to be significantly more expensive than ATA drives. Since ATA drives are used in very cost sensitive environments and produced in very large quantities, economies of scale allow pricing to be low. Manufacturers want to be able to take advantage of these low costs by using ATA drives in higher end applications. Further, some RAID techniques such as RAID51, RAID6 or triple mirroring can overcome inherent reliability disadvantages.

In today's environment where thousands of disks can exist in a storage device, hardware failures are bound to occur. Besides disk errors, transport errors can be created by SCSI cables, host bus adaptor card, device drivers, etc. Often such errors can go undetected, allowing corrupt data to propagate. This undetected data corruption occurs, for example, when an application program asks for data from the I/O subsystem (i.e. a disk read), and the data returned to that application is altered or lost without being detected or corrected. Altered Data is data that is present but corrupt or changed and no longer correctly represents the original data. Lost Data is data that is lost and no longer available. Such errors are unavoidable in today's technology, but a larger problem is when such errors go undetected. In critical applications, the results of undetected errors can be catastrophic.

One way to increase data integrity would be to generate check data using cyclic redundancy codes (CRC), longitudinal redundancy codes, Reed Solomon codes, or other checking techniques. This check data could be included with each 512 byte packet, for example, thereby resulting in enlarged packets such as 520 and 524-byte packets. Herein, enlarged will be used to describe a packet larger than a sector for writing packets therein. Although there are disks which can be formatted to contain larger sector sizes such as 520 or 524 bytes, it is much more common and cheaper to store all data to 512-byte sectors. In fact, drives such as ATA drives are not available with sector sizes other than 512 byte sectors. There is no inexpensive way for storing and processing these enlarged packet sizes to a standard formatted disk, such as a disk formatted with 512-byte sectors.

It can be seen that there is a need to provide a method, apparatus and program storage device to read from and write enlarged data packets to a storage formatted with sectors smaller than the enlarged packets.

It can also be seen that there is a need to provide a method, apparatus and program storage device for storing additional check data to increase the integrity of data that is stored to and retrieved from the storage device.

### SUMMARY OF THE INVENTION

To overcome the limitations in the prior art described above, and to overcome other limitations that will become apparent upon reading and understanding the present specification, the present invention discloses a method, apparatus and program storage device for providing data integrity using check data and other metadata on a formatted storage medium.

The present invention solves the above-described problems by allowing a predetermined number of packets having individual check data included with each packet and forming a first packet size, to be stored to a formatted storage device in which each sector on the storage device is formatted for a second packet size, such as a disk formatted with 512-byte sectors. Also, the invention provides additional check data included with the predetermined number of packets, wherein the additional check data can be stored in an unused portion of a sector used to store the predetermined number of packets.

A method of providing data integrity with a formatted storage device in accordance with the principles of the present invention includes processing a first number of packets having first predetermined lengths sized for a first number of sectors on the medium having a predetermined sector length and individual check data to form the first number of packets with second predetermined lengths having a total size requiring a second predetermined number of sectors for storage.

In another embodiment of the present invention a program storage device readable by a computer tangibly embodies one or more programs of instructions executable by the computer to perform a method for providing data integrity. The method includes processing a first number of packets having first predetermined lengths sized for a first predetermined number of sectors on the medium having a predetermined sector length and individual check data to form the first number of packets with second predetermined lengths having a total size requiring a second predetermined number of sectors for storage.

In another embodiment of the present invention a storage device is provided. The storage device includes a storage medium for storing data thereon, the storage medium formatted for a predetermined sector length, a transducer, operatively coupled to the storage medium, for reading and writing data on the storage medium and a processor, coupled to the transducer, for processing data to and from the transducer, the processor processing a first number of packets having first predetermined lengths sized for a first predetermined number of sectors on the storage medium having the predetermined sector length and individual check data to form the first number of packets with second predetermined lengths having a total size requiring a second predetermined number of sectors on the storage medium.

In another embodiment of the present invention a program storage device readable by a computer tangibly embodies one or more programs of instructions executable by the computer to perform a method for providing data integrity. The method includes processing 8 512 byte packets and individual check data to form 8 524 byte packets having a total size requiring 9 512 byte sectors for storage.

In another embodiment of the present invention a storage device is provided. The storage device includes a storage medium for storing data thereon, the storage medium formatted for 512 byte sectors, a transducer, operatively coupled to the storage medium, for reading and writing data on the storage medium and a processor, coupled to the transducer, for processing data to and from the transducer, the processor processing 8 512 byte packets and individual check data to form 8 524 byte packets having a total size requiring 9 512 byte sectors on the storage medium.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a storage system;

FIG. 2 is an illustration of one example of a magnetic disk drive storage system;

FIG. 3 illustrates a grouping of raw data packets used in a storage system according to the present invention;

FIG. 4a illustrates one embodiment of a data packet according to the present invention;

FIG. 4b illustrates a predetermined number of packets that include additional information according to the present invention;

FIG. 5 illustrates a number of sectors needed to store data packets including additional information on a storage device according to the present invention;

FIG. 6 is a flowchart for storing checking and metadata to a storage device according to the present invention;

FIG. 7 is a flowchart for reading checking and metadata from a storage device according to the present invention; and

FIG. 8 illustrates a system that stores check data and metadata according to the present invention.

### DETAILED DESCRIPTION OF THE INVENTION

In the following description of the exemplary embodiment, reference is made to the accompanying drawings, which form a part hereof, and in which is shown by way of illustration the specific embodiment in which the invention may be practiced. It is to be understood that other embodiments may be utilized as structural changes may be made without departing from the scope of the present invention.

The present invention provides a method, apparatus and program storage device for providing data integrity using check data and other metadata on a formatted storage medium. The present invention allows a predetermined number of packets having individual check data included with each packet to be stored to a formatted storage device in which each sector on the storage device is formatted for a second packet size, such as a disk formatted with 512-byte sectors. Also, the invention provides additional check data included with the predetermined number of packets, wherein the additional check data can be stored in an unused portion of a sector used to store the predetermined number of packets.

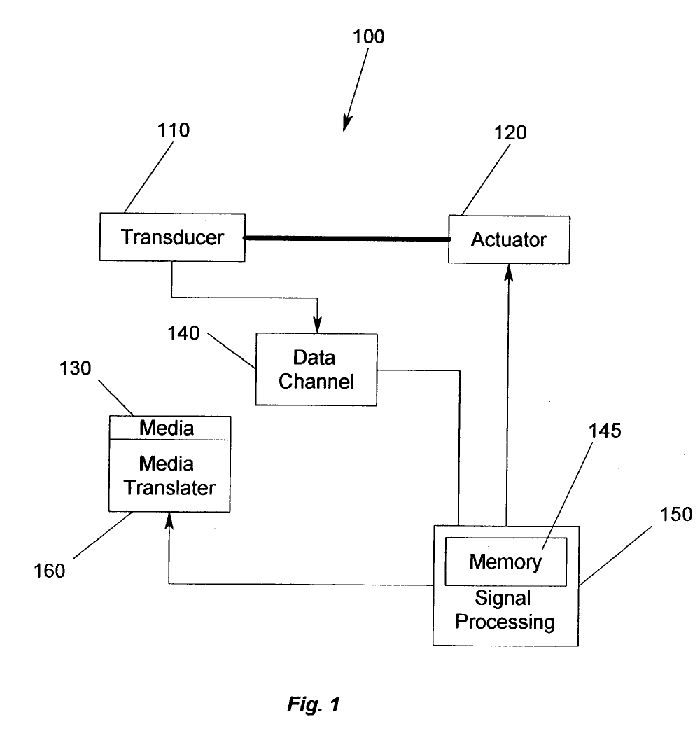

FIG. 1 illustrates a storage system 100. In FIG. 1, a transducer 110 is under control of an actuator 120. The actuator 120 controls the position of the transducer 110. The transducer 110 writes and reads data on magnetic media 130. The read/write signals are passed to a data channel 140. A signal processor 150 controls the actuator 120 and processes the signals of the data channel 140. The processor 150 may contain memory 145. In addition, a media translator 160 is controlled by the signal processor 150 to cause the magnetic media 130 to move relative to the transducer 110. The present invention is not meant to be limited to a particular type of storage system 100 or to the type of media 130 used in the storage system 100.

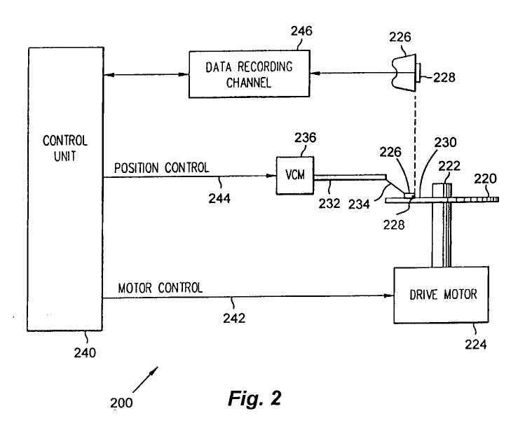

FIG. 2 is an illustration of one example of a magnetic disk drive storage system 200. As shown in FIG. 2, at least one rotatable magnetic disk 220 is supported on a spindle 222 and rotated by a disk drive motor 224. The magnetic recording media on each disk 220 is in the form of an annular pattern of concentric data tracks (not shown).

At least one slider 226 is positioned on the disk 220, each slider 226 supporting one or more magnetic read/write heads 228, wherein the heads 228 incorporate a sensor. As the disk(s) 220 rotate, slider 226 is moved radially in and out over disk surface 230 so that the heads 228 may access different portions of the disk 220 wherein desired data may be recorded or written. Each slider 226 is attached to an actuator arm 232 by means of a suspension 234. The suspension 234 provides a slight spring force, which biases the slider 226 against the disk surface 230. Each actuator arm 232 is attached to an actuator 236. The actuator 236 may, for example, be a voice coil motor (VCM). The direction and speed of the actuator is controlled by position signals 244 supplied by a control unit 240.

During operation of the disk drive 200, the rotation of the disk 220 generates an air bearing between the slider 226 and the disk surface 230, which exerts an upward force or lift on the slider 226. The surface of the slider 226, which includes the heads 228 and faces the surface of disk 220 is referred to as an air-bearing surface (ABS). The air bearing thus counter-balances the slight spring force of suspension 234 and, during normal operation, supports the slider 226 off of, and slightly above, the disk surface 230 at a small, substantially constant spacing.

The various components of the disk drive 200 are controlled in operation by control signals generated by a control unit 240, such as access control signals and internal clock signals. Typically, control unit 240 has logic control circuits, storage apparatus, and a microprocessor. The control unit 240 generates control signals to control various system operations such as position control signals 242 and motor control signals 244. The motor control signals 244 provide the desired profiles to optimally move and position the slider 226 to the desired data track on the disk 220. Read and write signals are communicated to and from the read/write heads 228 through a recording channel 246.

The above description of a typical magnetic disk drive storage system 200 is for representation purposes only. It should be apparent that disk storage systems may contain a large number of disks and actuators, and that each actuator may support a number of sliders. Many other variations of the basic typical magnetic disk drive storage system 200 may be used in conjunction with the present invention while keeping within the scope and intention of the invention. However, those skilled in the art will recognize that the present invention is not meant to be limited to magnetic disk drive storage systems as illustrated in FIG. 2.

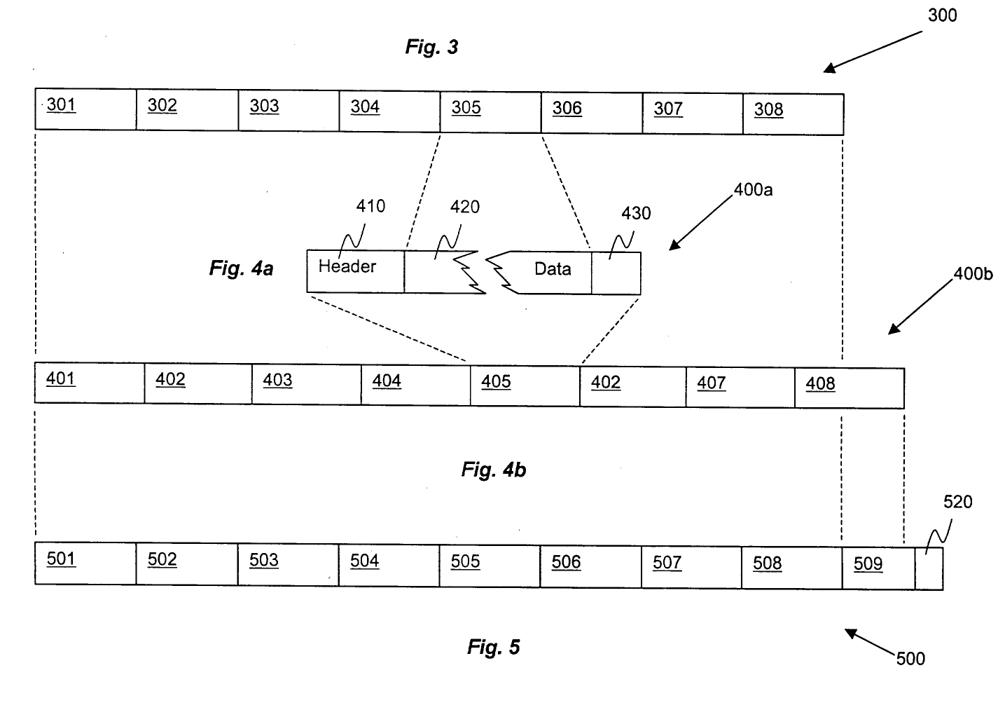

FIG. 3 illustrates a grouping of raw data packets 300 used in a storage system according to the present invention. In FIG. 3, one way to provide an effective, reliable, low latency data flow between a processor's memory (FIG. 1, 145), such as a central processing unit's (CPU) memory, and a storage device (FIG. 1, 130), such as a direct access storage device (DASD), is to transfer multiple packets of data 301-308 at a time.

It is less expensive to acquire and store all data to a storage device having a commonly formatted sector size, such as a storage device formatted with 512-byte sector sizes. Most storage systems will fetch or write a number of sectors at a time, such as eight sectors, transferring, for example, 4096 or 4K bytes worth of data. Hence, for example, data to be transferred to or read from a DASD may contain eight 512-byte sectors (i.e., 4096 bytes).

FIG. 4a illustrates one embodiment of a data packet 400a according to the present invention. To maintain data integrity for a data packet 400a, additional check data 430 is added to each packet. The check data 430 may be formed by, but not limited to, cyclic redundancy codes (CRC), longitudinal redundancy codes, Reed Solomon codes and packet sequence numbers. Also, other information may be included with each packet, such as control information, sector identification, and offset information etc.

In FIG. 4a, a data packet 400a is formed by a predetermined number of bytes 420, such as 512-bytes. In addition, the data packet 420 may include metadata such as header information 410 and check data 430. For example, a 524-byte data packet 400a may be formed by including 8 bytes of header information 410 and 4 bytes of check data 430 to 512 bytes of data 420. However, the invention is not limited to forming a data packet 400a in this manner or with the number of bytes of metadata given as an example.

FIG. 4b illustrates a predetermined number of packets 400b that include additional information according to the present invention. Even though there are storage devices, such as disk drives, which can be formatted to contain different sector sizes, such as 520-byte or 524-byte sectors as described in FIG. 4a, it is much more common and cheaper to store all data as 512-byte sectors.

These storage devices having 512-byte formatted sectors may be half or a third of the cost of a storage device formatted with other sector sizes. Moreover, these inexpensive storage devices formatted with 512-byte sectors may be used to store the different sized data packets, such as the 524-byte data sector described above.

In FIG. 4b, a data structure 400b containing multiple sectors 401-408 are shown. Each individual packet 401-408 contains header information and check data included with raw data (e.g., FIG. 4a, 420). For example, each packet may contain a 524-byte data packet 401-408 formed by including 8 bytes of header information and 4 bytes of check data to 512 bytes of data. However, in order to store the above formed 524-byte data packets 401-408 to a disk formatted with, for example, 512 byte sectors, at least one additional 512-byte sector on a storage device will be needed, in contrast to a number of sectors needed to store the original data packets 301-308 of FIG. 3. Taking one extra sector out of nine sectors is low overhead considering how much less a standard 512 byte sector formatted drive might cost.

FIG. 5 illustrates a number of sectors 500 needed to store data packets including additional information on a storage device according to the present invention. In FIG. 5, in order to store packet having a first packet length (e.g., packets having header information and check data included therewith) to a formatted sector of a storage device having a second size (e.g., sectors formatted with 512-bytes), additional sectors on the formatted storage device will be used. For example, in order to store the 524-byte packets as described in FIG. 4 to a disk formatted with 512-byte sectors, eight of these 524 byte sectors (FIG. 4, 401-408) will be stored in nine 512-byte sectors 501-509.

In addition, block check data for the data structure 400b is calculated and stored in an unused portion of the data sectors 501-509, such as in an unused portion of the ninth sector 509. For example, block check data 520 for the eight 524-byte packets (i.e., 4192 bytes) is calculated and stored in an unused portion of the ninth sector 509. However, the invention is not limited to using the unused portion of the ninth sector and other locations in a memory may be used. The block check data 520 may be generated using, but not limited to, cyclic redundancy codes (CRC), longitudinal redundancy codes, Reed Solomon codes, or another checking technique.

When data is read from a storage device, the block check data is examined followed by checking individual check data (FIG. 3, 330) of each of the individual packets (FIG. 4, 401-408). The block check data 520 may then discarded and the eight 524-byte packets (FIG. 4, 401-408) may be sent throughout a system allowing them to be checked in various places.

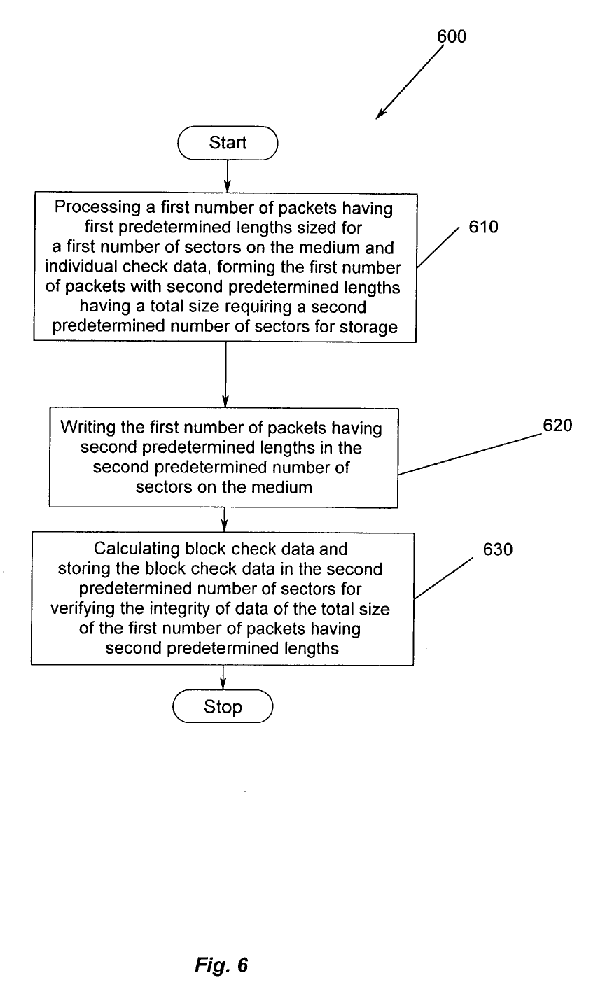

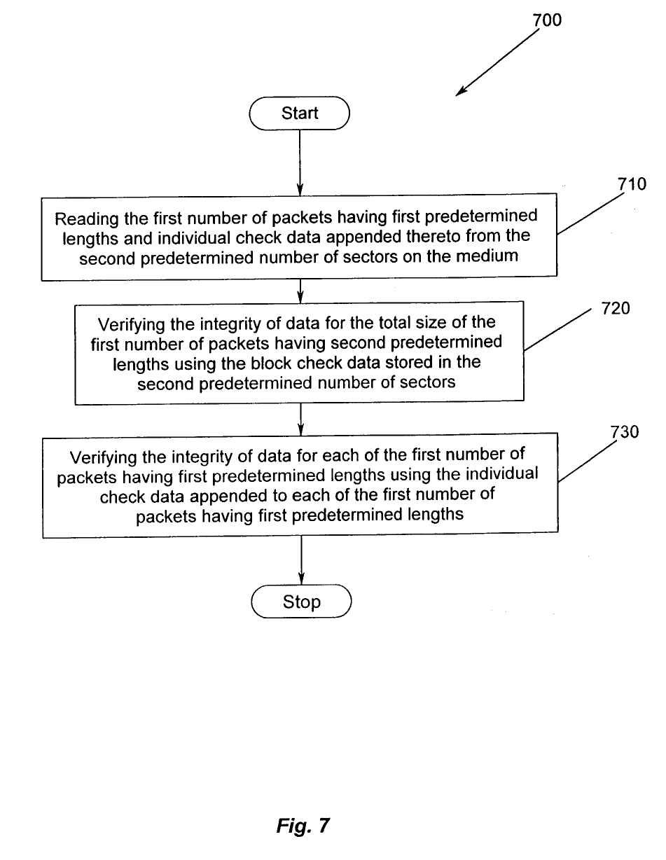

FIG. 6 is a flowchart 600 for storing checking and metadata to a storage device according to the present invention. In FIG. 6, a first number of packets having first predetermined lengths sized for a first number of sectors on the medium having a predetermined sector length and individual check data is processed to form the first number of packets with second predetermined lengths having a total size requiring a second predetermined number of sectors for storage 610. For example, eight data packets may be processed, each data packet containing 512 bytes of data and each data packet including 8 bytes of header information and 4 bytes of check data to form a 524-byte packet (i.e., to form a second predetermined length of 524 bytes). The first number of packets having first predetermined lengths may be sized for eight sectors on a medium in which each sector on the medium is 512 bytes.

The first number of packets having second predetermined lengths may be written in the second predetermined number of sectors on the medium 630. For example, in order to store the eight 524-byte packets to a storage medium formatted with 512-byte sectors, for example, nine 512-byte sectors will be used 630. In addition, a block check data may be calculated for the eight 524-byte packets (i.e., 4192 bytes) and stored in an unused portion of a sector on the storage medium, such as an unused portion of the ninth sector of the storage medium 640.

FIG. 7 is a flowchart 700 for reading checking and metadata from a storage device according to the present invention. In FIG. 7, a number of packets having first predetermined lengths and individual check data included therewith are read from a predetermined number of sectors on a storage medium 710. For example, eight 524-byte packets are read from nine sectors of the storage medium. Examining block check data that is stored in the second predetermined number of sectors may verify the integrity of data store in the predetermined number of sectors on the storage medium 720. The block check data is used to determine the validity of the total size of the first number of packets (i.e., a block of packets) having second predetermined lengths. The block check data may be stored in at least one of the second predetermined number of sectors.

The data may be further verified by examining the first number of packets having first predetermined lengths using the individual check data included therewith 730. For example, individual check data for each of the 524-byte packets is examined to determine the correctness of each packet. However, the invention is not limited to any order (e.g., block check data and individual check data) in validating the data stored in the medium.

The block check data may then be removed before the individual packets are transmitted. However, the invention is not limited to removing the block check data before transmitting the block of packets or transmitting the individual packets. For example, a block of data containing the first number of packets having second predetermined lengths and block check data may be read from the second predetermined number of sectors and processed.

Also, individual check data may be removed from each of the read packets to form packets having first predetermined lengths. For example, 8 bytes of header information and 4 bytes of check data are removed from each 524-byte packet to form 512-byte packets. These packets of a first predetermined length may then be further processed. However, the invention is not limited to removing individual check data before further processing (e.g., transmitting) the individual packets.

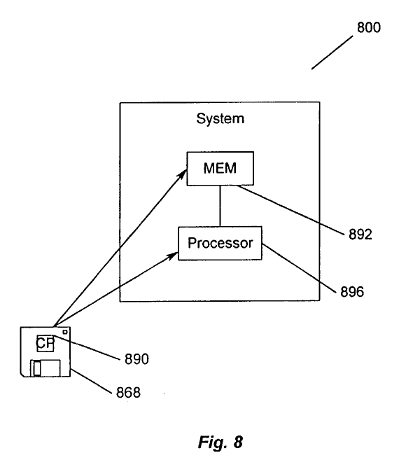

FIG. 8 illustrates a system 800 that stores check data and metadata according to the present invention using an executable program readable from a program storage device. The process illustrated with reference to the present invention may be tangibly embodied in a computer-readable medium or carrier, e.g. one or more of the fixed and/or removable data storage devices 868 illustrated in FIG. 8, or other data storage or data communications devices. A computer program 890 expressing the processes embodied on the removable data storage devices 868 may be loaded into the memory 892 or into the system 800, e.g., in a processor 896, to configure the system 800 of FIG. 8, for execution. The computer program 890 comprise instructions which, when read and executed by the system 800 of FIG. 8, causes the system 800 to perform the steps necessary to execute the steps or elements of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A method of providing data integrity on a formatted storage device, comprising:
processing a first number of packets having first predetermined lengths sized for a first number of sectors on the medium having a predetermined sector length and metadata to form the first number of packets with second predetermined lengths having a total size requiring a second predetermined number of sectors for storage.

2. The method of claim 1, wherein the metadata comprises individual check data.

3. The method of claim 1, wherein the processing further comprises reading the first number of packets having first predetermined lengths and metadata comprising individual check data included therewith from the second predetermined number of sectors on the medium.

4. The method of claim 3, wherein the reading further comprises verifying the integrity of data for the first number of packets having first predetermined lengths using the individual check data included with each of the first number of packets having first predetermined lengths.

5. The method of claim 1, wherein the processing further comprises including the metadata comprising individual check data with the first number of packets having first predetermined lengths to form the first number of packets having second predetermined lengths and writing the first number of packets having second predetermined lengths in the second predetermined number of sectors on the medium.

6. The method of claim 1 wherein the metadata comprises block check data stored in the second predetermined number of sectors for verifying the integrity of data for the total size of the first number of packets having second predetermined lengths.

7. A program storage device readable by a computer tangibly embodying one or more programs of instructions executable by the computer to perform a method for providing data integrity, the method comprising processing a first number of packets having first predetermined lengths sized for a first predetermined number of sectors on the medium having a predetermined sector length and metadata to form the first number of packets with second predetermined lengths having a total size requiring a second predetermined number of sectors for storage.

8. The program storage device of claim 7, wherein the metadata comprises individual check data.

9. The program storage device of claim 7, wherein the processing further comprises reading the first number of packets having first predetermined lengths and metadata comprising individual check data included therewith from the second predetermined number of sectors on the medium.

10. The program storage device of claim 9, wherein the reading further comprises verifying the integrity of data for the first number of packets having first predetermined lengths using the individual check data included with each of the first number of packets having first predetermined lengths.

11. The program storage device of claim 7, wherein the processing further comprises including the metadata comprising individual check data with the first number of packets having first predetermined lengths to form the first number of packets having second predetermined lengths and writing the first number of packets having second predetermined lengths in the second predetermined number of sectors on the medium.

12. The program storage device of claim 7, wherein the processing further comprises processing the first number of packets having first predetermined lengths being less than second predetermined lengths and the first predetermined number sectors for the first number of packets having first predetermined lengths being less than the second predetermined number of sectors for the first number of packets having second predetermined lengths.

13. The program storage device of claim 12, wherein the processing further comprises
processing eight packets having the first predetermined lengths of 512 bytes sized for eight sectors on the medium and the metadata comprising individual check data to form eight packets having the second predetermined lengths of 524 bytes having a total size requiring nine sectors on the medium for storage; and
writing the eight packets having the second predetermined lengths of 524 bytes in the nine sectors on the medium.

14. The program storage device of claim 12, wherein the processing further comprises
reading eight packets having the second predetermined lengths of 524 bytes from nine sectors on the medium; and
processing the eight packets having the second predetermined lengths of 524 bytes to form eight packets having the first predetermined lengths of 512 bytes sized for eight sectors on the medium and metadata comprising individual check data.

15. The program storage device of claim 12, wherein the metadata comprises block check data stored in the second predetermined number of sectors for verifying the integrity of data for the total size of the first number of packets having second predetermined lengths.

16. A storage device for providing data integrity on a formatted storage medium, comprising:
a storage medium for storing data thereon, the storage medium formatted for a predetermined sector length;
a transducer, operatively coupled to the storage medium, for reading and writing data on the storage medium; and
a processor, coupled to the transducer, for processing data to and from the transducer, the processor processing a first number of packets having first predetermined lengths sized for a first predetermined number of sectors on the storage medium having the predetermined sector length and metadata to form the first number of packets with second predetermined lengths having a total size requiring a second predetermined number of sectors on the storage medium.

17. The storage device of claim 16, wherein the metadata comprises individual check data.

18. The storage device of claim 16, wherein the individual check data is included with each of the first number of packets having first predetermined lengths for verifying the integrity of data for the first number of packets having first predetermined lengths.

19. The storage device of claim 16, wherein the processor provides the first number of packets having first predetermined lengths and metadata comprising individual check data included therewith for writing to the second predetermined number of sectors on the medium.

20. The storage device of claim 16, wherein the first number of packets is less than the second number of packets, and the first predetermined lengths and the first predetermined sector length are less than the second predetermined lengths.

21. The storage device of claim 16, wherein the first number of packets is eight, the first predetermined number of sectors is eight and the second predetermined number of sectors is nine.

22. The storage device of claim 16, wherein the first predetermined lengths are 512 bytes, the first predetermined sector length is 512 bytes and the second predetermined lengths are 524 bytes.

23. The storage device of claim 16, wherein the predetermined sector length is 512 bytes.

24. The storage device of claim 16, wherein the metadata comprises block check data stored in the second predetermined number of sectors for verifying the integrity of data for the total size of the first number of packets having second predetermined lengths.

25. A program storage device readable by a computer tangibly embodying one or more programs of instructions executable by the computer to perform a method for providing data integrity, the method comprising processing 8 512 byte packets and metadata to form 8 524 byte packets having a total size requiring 9 512 byte sectors for storage.

26. A storage device for providing data integrity on a formatted storage medium, comprising:
a storage medium for storing data thereon, the storage medium formatted for 512 byte sectors;
a transducer, operatively coupled to the storage medium, for reading and writing data on the storage medium; and
a processor, coupled to the transducer, for processing data to and from the transducer, the processor processing 8 512 byte packets and metadata to form 8 524 byte packets having a total size requiring 9 512 byte sectors on the storage medium.
